(19) United States
(12) Patent Application Publication
(10) Pub. No.: US 2015/0348589 A1
(43) Pub. Date: Dec. 3, 2015

(54) DIGITAL VIDEO SHOWROOM

(71) Applicant: Automotive Networks Corporation, Acton, MA (US)

(72) Inventors: James A. Barisano, III, Littleton, MA (US); Lehel Reeves, Ayer, MA (US); Collin Davis, Los Angeles, CA (US)

(73) Assignee: AUTOMOTIVE NETWORKS CORPORATION, Acton, MA (US)

(21) Appl. No.: 14/722,581

(22) Filed: May 27, 2015

Related U.S. Application Data
(60) Provisional application No. 62/003,672, filed on May 28, 2014.

(51) Int. Cl. G11B 27/10; G06Q 30/06; G11B 15/44; G06F 3/0484; G11B 27/30

(52) U.S. Cl. CPC G11B 27/102; G06F 3/04842; G06F 3/04847; G11B 27/3036; G11B 15/44; G06Q 30/0623

(57) ABSTRACT

The Digital Video Showroom is an interactive video platform used for researching, shopping for and comparing consumer products and services. Informational videos are composed of video chapters containing specific information. Each chapter can be immediately accessed without waiting for the information to appear as in a linear video.

### CROSS REFERENCE TO RELATED APPLICATIONS

The present application claims the benefit of U.S. Provisional Patent Application No. 62/003,672, filed on May 28, 2014, which is incorporated herein by reference in its entirety.

### BACKGROUND

A global market exists for goods and services used for researching and shopping for consumer products including Internet shopping and research data services. There are hundreds of consumer product shopping and research services.

Video has been used for many years to promote, advertise, review, demonstrate and examine products, services and destinations. Examples of videos used for these purposes are automobile video test drives, product overviews, video tours, infomercials and video reviews that have aired on broadcast and cable television and on the Internet. Interactive video, in which specific video programs can be viewed on-demand has been in use for a number of years, as well.

### SUMMARY

Conventional video used promotional and advertisement services, such as those explained above suffer from a variety of deficiencies. One such deficiency is the inability of consumers to quickly access specific desired information or to make direct comparisons between specific features and benefits of similar products of interest selected by the consumer. Accessing the desired information may require extensive viewing of the full program or use of the forward/rewind search capabilities of the video player to reach the pertinent information. Users of video programs must sit through portions of the programs of less immediate interest in order to receive the information they want and need. The alternatives in the online environment include using the scrub bar to advance the program to the desired information or scrolling through stills drawn from various portions of the program. These methods are neither accurate nor do they provide immediate access to chapters. The only alternative in the television On Demand environment is to rapid search through the video program in the hope of finding the information of immediate interest.

Embodiments of the present invention provide a Digital Video Showroom (DVS) which improves and enhances the method by which consumers shop and research products. Embodiments include, but are not limited to Digital Video Showroom videos of vacation destinations, homes, appliances and motor vehicles. The Digital Video Showroom provides consumers with the ability to do interactive research on products, view videos with instant access to chapters focused upon specific attributes of the product, compare product features, and interact with the provider of the product.

The Digital Video Showroom is suited for most consumer products. The Digital Video Showroom is a major improvement over the traditional method of shopping online. Typically, products and services offered online are presented using a mix of text, photographs and linear video. 84% of online shoppers watch videos on their products. The Achilles Heel of these videos is that one cannot instantly find the information of highest interest to the viewer.

The Digital Video Showroom helps consumers to find the most appropriate products and services for their needs more easily by using a video format that can immediately and interactively provide the specific information desired by the consumers while allowing consumers to do so using mobile, Internet, IPTV, and on-demand television. This solution creates an interactive video program about each product that is segmented into chapters (also referred to herein as chapters) and in which chapters covering specific features and benefits can be immediately accessed and played. Chapters are portions of the fully assembled video, and may be video or still images, either alone or with audio or text overlaid.

One embodiment creates such interactive video programs about cars for the motor vehicle sales market, but the same method may be applied to anything consumers may consider purchasing or want to review when considering multiple competing potential purchases. These include, but are not limited to, appliances, furniture, vacation destinations, real estate and the like. Informational videos are assembled for each product, with portions or chapters within each video identified by cue points. For example, the DVS video for a car may include a virtual test drive and include chapters about price, fuel efficiency, safety, interior features, performance, warranty, etc. Playback of the video using the Digital Video Showroom may be through any standard video playback access medium, including online video accessed on a computer, mobile device, smart phone, tablet or video streamed to a television through a cable or satellite box or other video access device. Chapters may be selected as chapters in the video, or through video control links from a custom application or direct URL. Alternatively, Flash controls, visible buttons or a menu may be set up to allow video control and selection of specific chapter cues.

Another embodiment is for selecting a vacation destination. The attributes of the vacation destination are each given a chapter: Hotel Overview, Room Tour, Beach, Amenities, Restaurants, Activities, the Area, etc. Consumers can select the subject of highest interest first or watch the video in natural sequence. Interactions are logged and metrics on which attribute is of highest interest are calculated to help the business to better serve its consumers.

Data gathering may track which videos are selected, which chapters are viewed, the number of views of each video and each chapter, and how much time is spent viewing each chapter. This may be used in the direct sales process, for product review purposes, for tailoring future content based on what is requested and focused on by consumers, and for determining consumer interest in specific product or service attributes that are presented in each chapter.

The Digital Video Showroom solution is able to provide per-product videos composed of attribute-specific chapters and provide view cues or link points to each chapter. The Digital Video Showroom is suited for most consumer products. A preferred embodiment of the invention is for researching and shopping for motor vehicles. It is a major improvement over the traditional method of shopping for a vehicle by visiting dealer showrooms and/or viewing linear video programs prior to visiting a dealer showroom. The Digital Video Showroom speeds the research process and saves time and money for the consumer while helping the auto dealer to sell more cars in less time to better qualified prospects.

The Digital Video Showroom provides instant access to the video and audio information that the consumer immediately wants and needs by providing a modularized format with each chapter identified as to what the consumer can expect in that chapter i.e. performance data, pricing, warranty, etc. The Digital Video Showroom is an easy and quick way to shop for and research consumer products and services such as a new or used vehicle. With the online version of the Digital Video Showroom, the consumer selects a new or used vehicle from a menu which is linked to a library of interactive automotive informational videos. The consumer is then brought to the model page of the vehicle they've chosen. The consumer is able to use a variety of features on the model page to do their shopping, researching and comparing.

Consumers can jump to any point in the video based on what interests them most about that vehicle. This jump is done instantly, without the need for buffering. Performance, safety, comfort/convenience, price, warranty, fuel economy and features are all covered in brief (e.g., 10-30 second) clips. Consumers can read the brief summary description about the vehicle or “View More” to read along the entire script with the video. Consumers can view additional video content on specific vehicle attributes in the “Tell Me More” chapter, including a message from the automaker, historical pieces, or details on vehicle performance, safety and technology. Consumers can do video comparisons with multiple vehicles. Consumers can read consumer reviews/comments, expert reviews, ratings, and vehicle tech specs about the vehicle. Consumers can rate, comment, or virally share the vehicle video. Consumers can view consumer review videos and upload their own video reviews. Consumers can get coupons good for discounts on service, tires and parts. Consumers can request a price instantly on a vehicle from dealers within their area.

By way of the Digital Video showroom, a consumer can instantly access the video information they desire without waiting for it to appear as in a linear video program. The consumer can control the viewing experience so that what is important to the consumer is viewed and what is not important need not be viewed. A consumer's control of the process leads to greater engagement. A consumer can more quickly determine if a particular product or service is of high or low interest. A buying or not buying decision by the consumer can more quickly be made. A consumer's interactive research helps the consumer to more quickly and effectively make an educated decision.

Sellers of the products or services offered have the opportunity to deal with consumers who are closer to a final purchase decision, are better educated and know what product or service data is important to them. Accumulated data of consumer interaction helps product and service providers to better tailor their offerings to consumers' needs and wants. Consumers achieve a more satisfying purchase and ownership experience. All involved in commerce using the Digital Video Showroom save time and energy with a more efficient purchase process, a better fit to consumers' needs, a greater understanding of features and benefits important to the specific consumer and fewer returns to the seller.

This invention relates to using interactive electronic video media to shop for and research a consumer product and take a virtual tour, test drive, walk-through or walk-around with the use of a computer, television, tablet or mobile device. The Digital Video Showroom competes in the global market with other forms of interactive video presentation.

This invention will help merchants sell, book, promote and lease more quickly and easily while allowing consumers to have instant video access to the features, benefits and attributes of highest interest to them. This ability to select specific subjects by using a mouse, pointer, remote control, touch or voice command and view the selected chapter immediately is a key differentiator of the Digital Video Showroom.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

In a particular embodiment of a method for providing a Digital Video Showroom, the method includes providing a video of a product a customer has selected to review, the video including a plurality of selectable chapters, each chapter relating to a specific attribute of the product. The method further includes enabling a user to select a chapter and in response to a user selecting a chapter, altering a playback position of the video to play the selected chapter. Additionally the method includes enabling playing of the video.

Other embodiments include a computer readable medium having computer readable code thereon for providing a Digital Video Showroom. The computer readable medium includes instructions for providing a video of a product a customer has selected to review, the video including a plurality of selectable chapters, each chapter relating to a specific attribute of the product. The computer readable medium further includes instructions for enabling a user to select a chapter and in response to a user selecting a chapter, altering a playback position of the video to play the selected chapter. Additionally the computer readable medium includes instructions for enabling playing of the video.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides a Digital Video Showroom as explained herein that when performed (e.g. when executing) on the processor, operates as explained herein within the computerized device to perform all of the method embodiments and operations explained herein as embodiments of the invention. Thus any computerized device that performs or is programmed to perform the processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing a Digital Video Showroom as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more chapters, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 depicts a diagram of an environment using a Digital Video Showroom in accordance with a particular embodiment of the present invention.

FIG. 2 depicts a first screen shot view of a web site using a Digital Video Showroom in accordance with a particular embodiment of the present invention.

FIG. 3 depicts a second screen shot view of a web site using a Digital Video Showroom in accordance with a particular embodiment of the present invention.

FIG. 4 depicts a third screen shot view of a web site using a Digital Video Showroom in accordance with a particular embodiment of the present invention.

FIG. 5 depicts a fourth screen shot view of a web site using a Digital Video Showroom in accordance with a particular embodiment of the present invention.

FIG. 6 depicts a Quick Response (QR) code for using a Digital Video Showroom in accordance with a particular embodiment of the present invention.

FIG. 7 depicts a flow diagram of a particular embodiment of a method for providing a Digital Video Showroom in accordance with a particular embodiment of the present invention.

FIG. 8 depicts a block diagram of a computer system for providing a Digital Video Showroom in accordance with a particular embodiment of the present invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

In the following detailed description of the invention, reference is made to the accompanying drawings which form a part hereof, and in which are shown, by way of illustration, specific embodiments in which the invention may be practiced. It is to be understood that other embodiments may be used, and structural changes may be made without departing from the scope of the present invention.

The terminology and definitions of the prior art are not necessarily consistent with the terminology and definitions of the current invention. Where there is a conflict, the following definitions apply.

Informational videos are videos created describing an item with specific chapters within the video about specific aspects of the item. Viewing informational videos of multiple similar products allows consumer comparison of specific aspects through synchronized viewing of the same chapter within each video.

Items are the subject matter for which an informational video may be created. They may be goods or services, people, places, or things, or concepts such as educational material.

Chapters are portions or sections of an informational video focused about a specific aspect of the subject of the video. Chapters have identifiable start and end points within the video, and a name describing the aspect which is the focus of the chapter.

Video platforms include any server-based system capable of distributing video. This may further include local storage, remote storage and cloud based servers and storage. Examples include internet-connected servers making video available for download or streaming, or broadcast systems such as on-demand libraries delivering video via cable or satellite.

A viewing device is any device capable of access and display of video. Examples include televisions, internet-connected computers, smartphones, tablets, and other mobile computing devices.

A video window is a region on the viewing device playing back video. For example, a video window on a computer within a web browser may be the portion of a webpage displaying video. Multiple video windows may be present at the same time, such as multiple videos displayed within a single webpage.

To create informational videos, standard video creation tools are used. Videos are typically shot in digital, high-definition format and edited with standard video editing software such as Final Cut Pro. During editing, graphics, text, and voice-overs may be added to the videos to produce informational videos. Informational videos are assembled for each item, with chapters or modules within each video identified by start and stop points within the entire video. For example, car videos may include chapters about price, fuel efficiency, safety, interior features, performance, warranty, etc. Chapters may be assembled with video or stills, and may optionally have informative data as text overlays. Specific graphics may be added at the beginning, end, or within each chapter to display relevant information. After final edit, the video is typically encoded into Flash Video or QuickTime H264 format. The encoded video may be uploaded to server for direct access or access within a video management platform.

After encoding the video is assigned cue points that reference various timestamps within the video corresponding to the start and stop of each chapter. Cue points can be assigned to the file itself via cue point injection as video chapters, by creating a timestamp reference document which may be uploaded to the server along with the video file, or by tracking the cue points inside a database for video management accessible by the server. Names for each chapter may be tracked in the file or database along with the start and end points for the chapter.

A particular embodiment is for shopping for motor vehicles. A consumer who is considering the purchase of a car will spend up to six months researching vehicles, observing vehicles on the road and determining what vehicles might be appropriate for their needs.

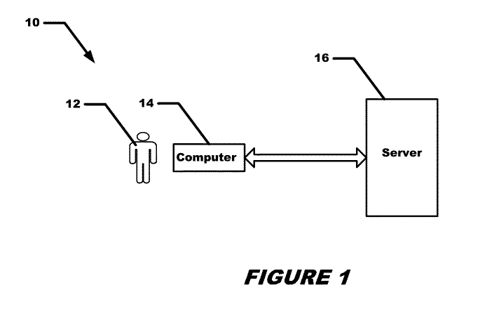

Referring to FIG. 1, a first environment 10 including a Digital Video Showroom is shown. A user 12 accesses a website by way of a viewing device 14. In this example viewing device 14 is a computer, but may alternatively be any device capable of showing video including, but not limited to, mobile phones, televisions, tablets, in-store displays or the like. In a typical embodiment 10 the viewing device 14 communicates with a server 16 to access a video. Such communication and access may be through a web browser across the Internet. Alternatively, video may be stored on viewing device 14 and accessed without need to communicate with server 16.

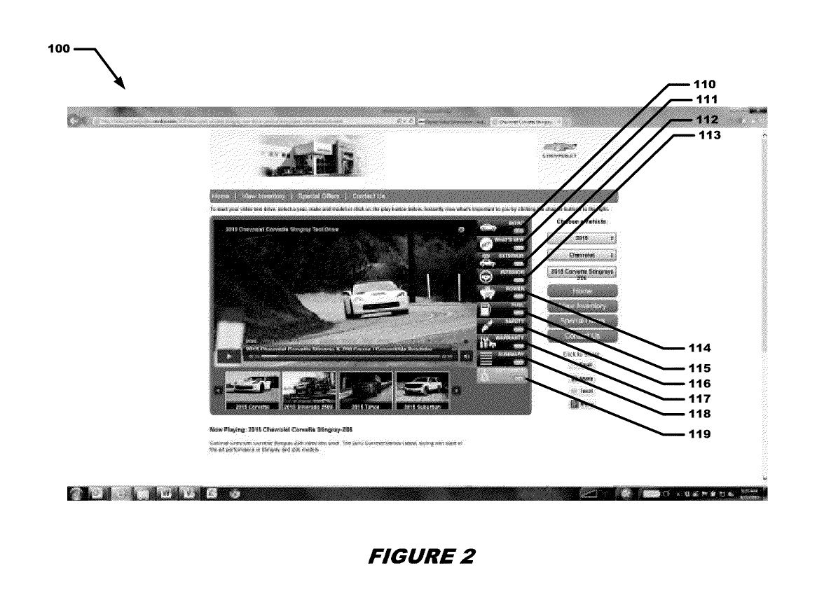

Referring now to FIGS. 2-5, the user uses viewing device 14 to access an informational video. In some embodiments this may include a pre-roll commercial for the hosting business. In a preferred embodiment, consumers use web browsers operated on computers 14 to access a website delivered from server 16 with lists of items available and select an item of interest. Alternatively, any device capable of allowing selection of an item and displaying a related information video may be used. After selecting an item, the consumer is presented with an informational video specific to the selected item, typically as a webpage with a video window and video playback controls. FIGS. 2-5 show an example embodiment of presentation of an informational video 100. Video playback may be through any standard format, such as, but not limited to, Flash Video or QuickTime 264, capable of playback on viewing device 14. In addition to video playback, selection control buttons 110-119 are displayed for access to specific chapters within the video. Selection control buttons include starting and stopping playback, as well as jumping playback to a specific chapter. Names of available chapters may be included based on the data tracked with the cue points. Upon selecting a specific chapter control button, the timestamp for the related cue point is used to jump playback of video to the selected chapter.

After completion of a chapter, video playback may continue to the next chapter. However, in a preferred embodiment video playback stops at the end of the selected chapter and continues only after consumer selection of another chapter. As start and end points of each chapter may be tracked by file or database, playback may start at the beginning of a chapter and have a set stop point at the end.

The selection control buttons 110-119 may include a selectable list of all available chapters in the informational videos for the selected items. In a preferred embodiment, all videos for the same type of items have the same set of chapters within each video. In the event that multiple items have a different set of chapters within each informational video, the selection controls may list all chapters existing in any selected video. Upon selection of a chapter for playback which is not in all videos, video playback for any informational video lacking that chapter may instead display an informational screen informing that such chapter is not available. This may be done through playback window controls or inserting such screen into the video stream delivered from the server.

Referring specifically to FIG. 2, a video 100 is shown. Video 100 has been selected by a user. While in this example a video for a selected car (2015 Chevrolet Stingray) is shown, the same concepts apply to different items, including but not limited to furniture, appliances, vacation destinations, etc. Each video for each item has a set of chapters. In this example video 100 includes ten chapters. The chapters are intro 110; what's new 111; exterior 112; interior 113; power 114, fuel 115; safety 116, warranty 117; summary 118; and get price 119. Each chapter has an associated status. In this example the status is indicated by a chapter status indicator as part of the chapter designator. In this example, since the intro chapter 110 is playing, the status indicator for this chapter is green 110. The status indicators for the remaining chapters 111-119 are yellow, indicating they have not yet been viewed.

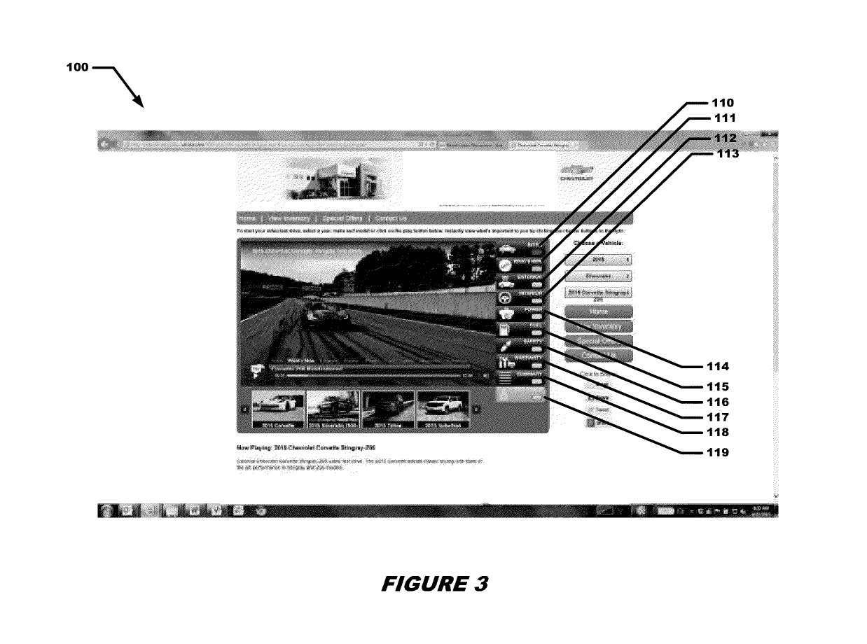

Referring now to FIG. 3, the next chapter labeled what's new 111 is playing. This chapter could have been selected by the user or automatically plays after chapter 110 is complete. The chapter status indicator for chapter 111 is now green, while the chapter status indicator for chapter 110 is now red, indicating that this chapter 110 has been watched. The chapter status indicators for the remaining chapters 112-119 are yellow, indicating they have not yet been viewed.

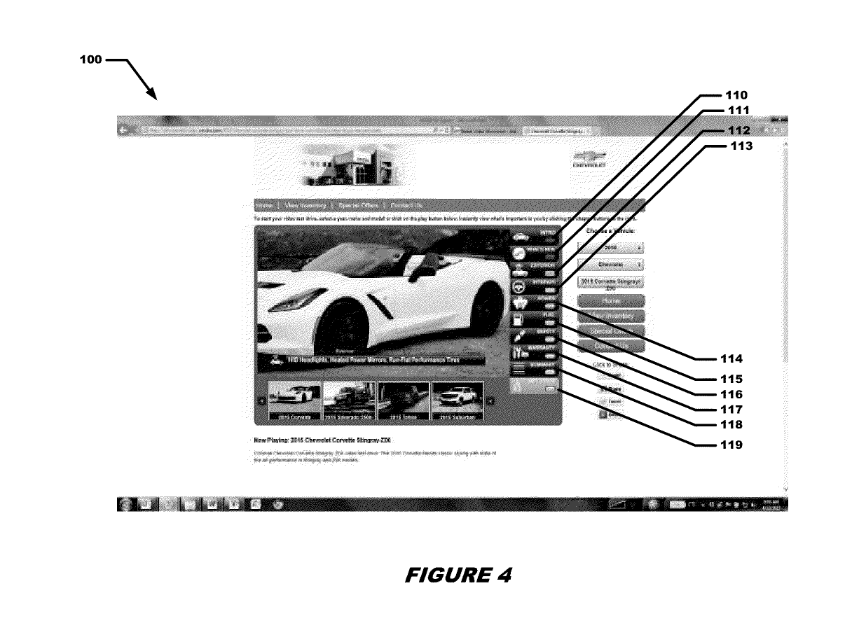

Referring now to FIG. 4, the next chapter labeled exterior 112 is playing. This chapter could have been selected by the user or automatically plays after chapter 111 is complete. The chapter status indicator for chapter 112 is now green, while the chapter status indicator for chapter 110 and chapter 111 are now red, indicating that these chapters have been watched. The chapter status indicators for the remaining chapters 113-119 are yellow, indicating they have not yet been viewed.

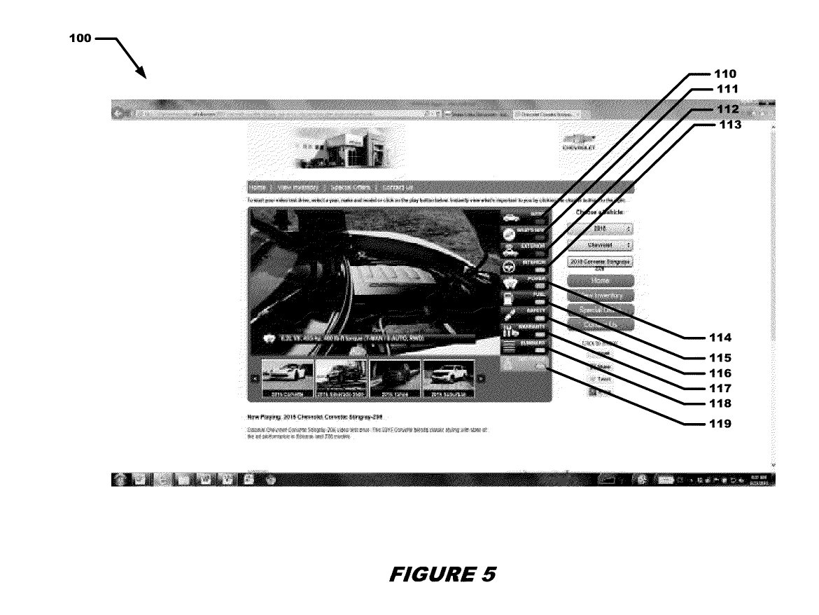

Referring now to FIG. 5, the chapter labeled power 114 is playing. This chapter has been selected by the user. The chapter status indicator for chapter 114 is now green, while the chapter status indicator for chapters 110-112 are now red, indicating that these chapters have been watched. The chapter status indicators for the remaining chapters 113 and 115-119 are yellow, indicating they have not yet been viewed.

When a video is selected by the user, the video is received from a video server storing a library of videos. The video 100 contains all the chapters 110-119, each chapter relating to a specific attribute of the product. The Digital Video Showroom utilizing the video enables a user to select a chapter and in response to a user selecting a chapter, altering a playback position of the video to play the selected chapter. In a particular embodiment the altering of a playback position of the video to play the desired chapter comprises moving the play position of the video of the selected chapter to a start timestamp associated with the selected chapter, triggering playback of the video of the selected chapter, and stopping playback of the video of the selected chapter when the play position reaches a stop timestamp associated with the selected chapter. The selected video may be played by way of an overlay player on the website.

The overlay player is an extension/module of the DVS that can run on external pages of a website. The overlay player allows for uninterrupted viewing experience on a website while browsing a product or list of products. It keeps the user from leaving the page (the page remains in the background while the user watches the video).

The microsite is a standalone version of the DVS. The DVS iFrame (also known as DVS embed) is another module of the DVS that integrates into the website within an iFrame. This allows a video experience to be hosted within a shell that sits on the website.

In one embodiment the videos of the library of videos are updated to match an inventory of the website owner. In this way the library is synchronized with the items available and therefore does not include videos of items no longer in stock or on the menu or fail to provide videos of new items. Each vehicle in the dealer inventory is dynamically linked by its Vehicle Identification Number (VIN) to a video for that vehicle. At pre-determined time intervals (e.g., once a day) the data is updated and any new vehicles will have a video associated with that vehicle available and any vehicles that are no longer in inventory will have their link to the video removed.

Statistics (also referred to as analytics) can be tracked regarding which videos are selected, which chapters are viewed, the number of views of each video and each chapter, and how much time is spent viewing each chapter as well as the sequence of chapters viewed. The statistics tracked are not just a tool for measuring web traffic but can be used for business and market research, and to assess and improve the effectiveness of a website. The statistics provide information about the number of visitors to a website and the number of page views. It helps gauge traffic and popularity trends which is useful for market research.

Web analytics measure a visitor's behavior once on a website. This includes its drivers and conversions; for example, the degree to which different landing pages are associated with purchases. Web analytics measures the performance of a website in a commercial context. This data is typically compared against key performance indicators for performance, and used to improve a website or marketing campaign's audience response. Google Analytics® is the most widely used on-site web analytics service; although new tools are emerging that provide additional layers of information, including heat maps and session replay.

There are other applications for the Digital Video Showroom. Using a mobile device such as a tablet or smart phone, the user can select an item to be viewed from a menu or by indicating the item verbally or digitally and then choose specific chapters of that item's informational video, each which highlights information of relevance or importance to the user such as, in the case of an automobile, fuel economy, price, performance, safety, etc. IPTV Applications are also considered. For Smart TV platforms, the Digital Video Showroom may be downloaded as an application and used to view video on Internet-connected televisions in the same manner as used online in web browsers. Using a computer or smart television, the user can select an item to be viewed and then choose specific chapters, each which highlights information of relevance or importance to the user such as, in the case of an automobile, fuel economy, price, performance, safety, etc. Additional information may also be accessed by selected videos from a related video menu.

On-Demand Applications are also available. From a cable, satellite or telco provided on-demand service; the user may select videos of specific items as made available through an on-demand video library to the user's television. Through on-demand, informational videos can be selected and played back using readily available controls of the users remote to fast forward or rewind the video. The graphics on screen over the video help the user determine where they want to stop or begin playback for a particular chapter. The user can select an item to be viewed and then choose specific chapters, each which highlights information of relevance or importance to the user such as, in the case of an automobile, fuel economy, price, performance, safety, etc. Additional information may also be accessed by selected videos from a related video menu.

A further embodiment includes restaurant menus. The menu is available on a tablet device, and the user can select a menu item and receive information by of a video having chapters. A chapter may be regarding where the item is sourced, another chapter regarding how the item is prepared and served, another chapter regarding nutritional information, etc. The menu may contain QR codes so the different video and chapters are able to have their QR code scanned on a mobile device (e.g., a smart phone) and vie the video on their mobile device.

The Digital Video Showroom solves a common problem for consumers while saving time and energy for providers. The significant improvement embodied in the Digital Video Showroom is that consumers can quickly and easily determine if a vehicle has the attributes appropriate for their needs and wants by instantly accessing the chapters that address those specific needs and wants. With the Digital Video Showroom's interactivity, consumers do not have to wait for the desired information to appear in sequence within the video but can select and immediately view specific information within the video. By viewing video chapters of highest interest to them first, they can quickly narrow their choices, prioritize the most important attributes for their needs and move towards a purchase decision.

The Digital Video Showroom is an improvement over other forms of consumer product research and is particularly important when it comes to vehicles, which need to be viewed in motion in order to be fully appreciated: Shopping includes viewing interactive videos of the vehicle and selecting specific video chapters such as fuel economy, performance, safety features and warranty. The video then immediately plays that specific chapter.

Consumer interactions are tracked so that the merchant can determine what is most important to his customers. In the case of Internet deployment of the Digital Video Showroom, access to and from the main website of the merchant is seamless and done with a single click. In the auto dealer embodiment this can include but not be limited to getting a price, viewing inventory, contacting the dealer and viewing specials. In the vacation destination embodiment this can include but not be limited to pricing a vacation, viewing specials, contacting a customer service rep and scheduling a vacation.

The Digital Video Showroom can either be a welcome page of an existing auto dealership, designed to have a similar look and feel as the dealership, or it can stand alone It is to be understood that other embodiments may be used, and structural changes may be made without departing from the scope of the present invention.

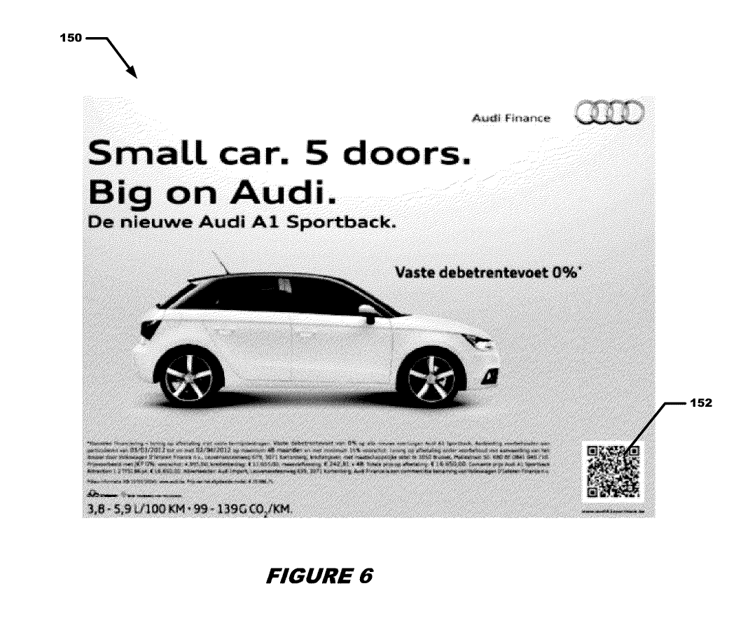

In some embodiments the video may be accessed by the user scanning a Quick Response (QR) code on a piece of printed material (newspaper, magazine, sticker on item, etc.). An example is shown in FIG. 6. A magazine ad 150 includes a QR code 152. Scanning the QR code 152 will lead the user to a Digital Video Showroom for the item.

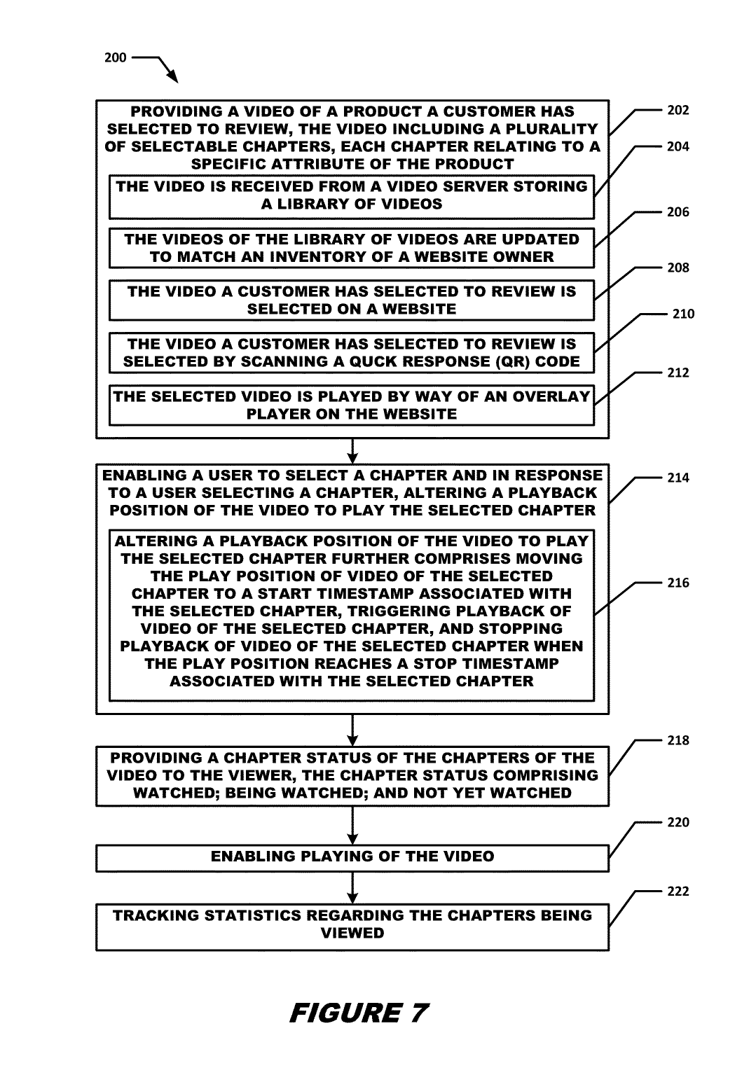

A flow chart of a particular embodiment of the presently disclosed method for providing a Digital Video Showroom is depicted in FIG. 7. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

In a particular embodiment method 200 begins with processing block 202 which discloses providing a video of a product a customer has selected to review, the video including a plurality of selectable chapters, each chapter relating to a specific attribute of said product. As shown in processing block 204, the video is received from a video server storing a library of videos.

Processing block 206 states that the library of videos are updated to match an inventory of a website owner. In such a manner, the library is synchronized with the items available and therefore does not include videos of items no longer on stock or fail to provide videos of new items.

Processing block 208 recites the video a customer has selected to review is selected on a website wherein a customer viewing the website has selected a product to review. Alternately, as shown in processing block 210 the video a customer has selected to review is selected by scanning a Quick Response (QR) code. As shown in processing block 212 the selected video is played by way of an overlay player on the website.

Processing continues with processing block 214 which discloses enabling a user to select a chapter and in response to a user selecting a chapter, altering a playback position of the video to play the selected chapter. This is accomplished in one embodiment as shown in processing block 216 which states wherein altering a playback position of the video to play the desired chapter further comprises moving the play position of video of the selected chapter to a start timestamp associated with the selected chapter, triggering playback of video of the selected chapter, and stopping playback of video of the selected chapter when the play position reaches a stop timestamp associated with the selected chapter.

Processing block 218 recites providing a chapter status of the chapters of the video to the viewer, the chapter status comprising watched; being watched; and not yet watched. Processing block 220 discloses enabling playing of the video, and processing block 222 states tracking statistics regarding the videos being viewed. The statistics can include which videos are selected, which chapters are viewed, the number of views of each video and each chapter, and how much time is spent viewing each chapter.

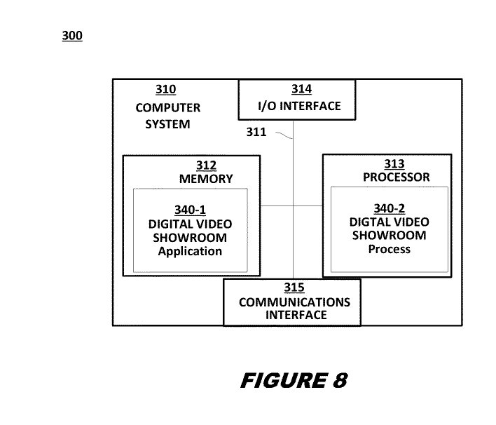

FIG. 8 is a block diagram illustrating example architecture 300 of a computer system 310 that executes, runs, interprets, operates or otherwise performs a Digital Video Showroom operating application 340-1 and Digital Video Showroom operating process 340-2 suitable for use in explaining example configurations disclosed herein. The computer system 310 may be any type of computerized device such as a personal computer, workstation, portable computing device, console, laptop, network terminal or the like. An input device 316 (e.g., one or more customer/developer controlled devices such as a keyboard, mouse, etc.) couples to processor 313 through I/O interface 314, and enables a customer 308 to provide input commands, and generally control the graphical customer interface 360 that the Digital Video Showroom operating application 340-1 and process 340-2 provides on the display 330. As shown in this example, the computer system 310 includes an interconnection mechanism 311 such as a data bus or other circuitry that couples a memory system 312, a processor 313, an input/output interface 314, and a communications interface 315. The communications interface 315 enables the computer system 310 to communicate with other devices (i.e., other computers) on a network (not shown).

The memory system 312 is any type of computer readable medium, and in this example, is encoded with a Digital Video Showroom operating application 340-1 as explained herein. The Digital Video Showroom operating application 340-1 may be embodied as software code such as data and/or logic instructions (e.g., code stored in the memory or on another computer readable medium such as a removable disk) that supports processing functionality according to different embodiments described herein. During operation of the computer system 310, the processor 313 accesses the memory system 312 via the interconnect 311 in order to launch, run, execute, interpret or otherwise perform the logic instructions of a Digital Video Showroom operating application 340-1. Execution of a Digital Video Showroom operating application 340-1 in this manner produces processing functionality in the Digital Video Showroom operating process 340-2. In other words, the Digital Video Showroom operating process 340-2 represents one or more portions or runtime instances of a Digital Video Showroom operating application 340-1 (or the entire a Digital Video Showroom operating application 340-1) performing or executing within or upon the processor 313 in the computerized device 310 at runtime.

It is noted that example configurations disclosed herein include the Digital Video Showroom operating application 340-1 itself (i.e., in the form of un-executed or non-performing logic instructions and/or data). The Digital Video Showroom operating application 340-1 may be stored on a computer readable medium (such as a floppy disk), hard disk, electronic, magnetic, optical, or other computer readable medium. A Digital Video Showroom operating application 340-1 may also be stored in a memory system 312 such as in firmware, read only memory (ROM), or, as in this example, as executable code in, for example, Random Access Memory (RAM). In addition to these embodiments, it should also be noted that other embodiments herein include the execution of a Digital Video Showroom operating application 340-1 in the processor 313 as the Digital Video Showroom operating process 340-2. Those skilled in the art will understand that the computer system 310 may include other processes and/or software and hardware components, such as an operating system not shown in this example.

During operation, processor 313 of computer system 300 accesses memory system 312 via the interconnect 311 in order to launch, run, execute, interpret or otherwise perform the logic instructions of the Digital Video Showroom application 340-1. Execution of Digital Video Showroom application 340-1 produces processing functionality in Digital Video Showroom process 340-2. In other words, the Digital Video Showroom process 340-2 represents one or more portions of the Digital Video Showroom application 340-1 (or the entire application) performing within or upon the processor 313 in the computer system 300.

It should be noted that, in addition to the Digital Video Showroom process 340-2, embodiments herein include the Digital Video Showroom application 340-1 itself (i.e., the un-executed or non-performing logic instructions and/or data). The Digital Video Showroom application 340-1 can be stored on a computer readable medium such as a floppy disk, hard disk, or optical medium. The Digital Video Showroom application 340-1 can also be stored in a memory type system such as in firmware, read only memory (ROM), or, as in this example, as executable code within the memory system 312 (e.g., within Random Access Memory or RAM).

In addition to these embodiments, it should also be noted that other embodiments herein include the execution of Digital Video Showroom application 340-1 in processor 313 as the Digital Video Showroom process 340-2. Those skilled in the art will understand that the computer system 300 can include other processes and/or software and hardware components, such as an operating system that controls allocation and use of hardware resources associated with the computer system 300.

It is to be understood that the above description is intended to be illustrative, and not restrictive. Many other embodiments will be apparent to those of skill in the art upon reviewing the above description.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), tablet(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, chapters, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer-implemented method in which a computer system performs operations comprising:
providing a video of a product a customer has selected to review, said video including a plurality of selectable chapters, each chapter relating to a specific attribute of said product;
enabling a user to select a chapter and in response to a user selecting a chapter, altering a playback position of said video to play the selected chapter; and
enabling playing of said video.

2. The method of claim 1 wherein said video is received from a video server storing a library of videos.

3. The method of claim 1 further comprising providing a chapter status of the chapters of said video to said viewer, said chapter status comprising watched; being watched; and not yet watched.

4. The method of claim 1 wherein said videos of said library of videos are updated to match an inventory of a website owner.

5. The method of claim 1 further comprising tracking statistics regarding said chapters being viewed.

6. The method of claim 1, wherein altering a playback position of said video to play the desired chapter further comprises moving the play position of video of the selected chapter to a start timestamp associated with the selected chapter, triggering playback of video of the selected chapter, and stopping playback of video of the selected chapter when the play position reaches a stop timestamp associated with the selected chapter.

7. The method of claim 1 wherein said video a customer has selected to review is selected on a website wherein a customer viewing said website has selected a product to review.

8. The method of claim 7 wherein said selected video is played by way of an overlay player on said website.

9. The method of claim 1 wherein said video a customer has selected to review is selected by scanning a Quick Response (QR) code.

10. A non-transitory computer readable storage medium having computer readable code thereon for a Digital Video Showroom, the medium including instructions in which a computer system performs operations comprising:
providing a video of a product a customer has selected to review, said video including a plurality of selectable chapters, each chapter relating to a specific attribute of said product;
enabling a user to select a chapter and in response to a user selecting a chapter, altering a playback position of said video to play the selected chapter; and
enabling playing of said video.

11. The computer readable storage medium of claim 10 wherein said video is received from a video server storing a library of videos.

12. The computer readable storage medium of claim 10 further comprising providing a chapter status of the chapters of said video to said viewer, said chapter status comprising watched; being watched; and not yet watched.

13. The computer readable storage medium of claim 10 wherein said videos of said library of videos are updated to match an inventory of a website owner.

14. The computer readable storage medium of claim 10 further comprising tracking statistics regarding said chapters being viewed.

15. The computer readable storage medium of claim 10, wherein altering a playback position of said video to play the desired chapter further comprises moving the play position of video of the selected chapter to a start timestamp associated with the selected chapter, triggering playback of video of the selected chapter, and stopping playback of video of the selected chapter when the play position reaches a stop timestamp associated with the selected chapter.

16. The computer readable storage medium of claim 10 wherein said video a customer has selected to review is selected on a website wherein a customer viewing said website has selected a product to review.

17. The computer readable storage medium of claim 16 wherein said selected video is played by way of an overlay player on said website.

18. The computer readable storage medium of claim 10 wherein said video a customer has selected to review is selected by scanning a Quick Response (QR) code.

19. A computer system comprising:
a memory;
a processor;
a communications interface;
an interconnection mechanism coupling the memory, the processor and the communications interface; and
wherein the memory is encoded with an application providing a Digital Video Showroom, that when performed on the processor, provides a process for processing information, the process causing the computer system to perform the operations of:
providing a video of a product a customer has selected to review, said video including a plurality of selectable chapters, each chapter relating to a specific attribute of said product;
enabling said user to select a chapter and in response to said user selecting a chapter, altering a playback position of said video to play the selected chapter; and
enabling playing of said video.

20. The computer system of claim 19 wherein said video is received from a video server storing a library of videos.
